(19) United States
(12) Patent Application Publication
(10) Pub. No.: US 2022/0237405 A1
(43) Pub. Date: Jul. 28, 2022

(54) DATA RECOGNITION APPARATUS AND RECOGNITION METHOD THEREOF

(71) Applicant: MACRONIX International Co., Ltd., Hsinchu (TW)

(72) Inventors: Yun-Yuan Wang, Kaohsiung City (TW); Feng-Min Lee, Hsinchu City (TW); Po-Hao Tseng, Taichung City (TW); Ming-Hsiu Lee, Hsinchu (TW)

(73) Assignee: MACRONIX International Co., Ltd., Hsinchu (TW)

(21) Appl. No.: 17/344,698

(22) Filed: Jun. 10, 2021

Related U.S. Application Data
(60) Provisional application No. 63/142,980, filed on Jan. 28, 2021.

(51) Int. Cl. G06K 9/62; G06K 9/46

(52) U.S. Cl. CPC G06K 9/6202; G06K 9/6215; G06K 9/46

(57) ABSTRACT

A data recognition apparatus and a recognition method are provided. The data recognition apparatus includes a data augmentation device, a feature extractor, and a comparator. The data augmentation device receives a plurality of target information and performs augmentation on each of the target information to generate a plurality of augmented target information. The feature extractor receives queried information and the augmented target information to extract features of the augmented target information and the queried information to respectively generate a plurality of augmented target feature values and a queried feature value. The comparator generates a recognition result according to the queried feature value and the augmented target feature values.

### CROSS-REFERENCE TO RELATED APPLICATION

This application claims the priority benefit of U.S. provisional application Ser. No. 63/142,980, filed on Jan. 28, 2021. The entirety of the above-mentioned patent application is hereby incorporated by reference herein and made a part of this specification.

### BACKGROUND

### Technical Field

The disclosure relates to a data recognition apparatus and a recognition method thereof, and in particular, relates to a data recognition apparatus and a recognition method thereof capable of improving recognition rates.

### Description of Related Art

At present, it is common to apply artificial intelligence to data recognition in the technical field.

In the related art, a memory is used most of the time to record multiple target information. When recognition occurs, the searched information is compared with the target information to look up the relevant data of the searched information. Nevertheless, the recognition rate of this approach is often limited by the volume of target information. Generally, with a limited volume of target information, the recognition rate of the data recognition apparatus is also limited.

### SUMMARY

The disclosure provides a data recognition apparatus and a recognition method thereof capable of improving recognition rates.

The disclosure provides a data recognition apparatus including a data augmentation device, a feature extractor, and a comparator. The data augmentation device receives a plurality of target information and performs augmentation on each of the target information to generate a plurality of augmented target information. The feature extractor is coupled to the data augmentation device. The feature extractor receives queried information and the augmented target information to extract features of the augmented target information and the queried information to respectively generate a plurality of augmented target feature values and a queried feature value. The comparator generates a recognition result according to the queried feature value and the augmented target feature values.

The disclosure further provides a data recognition method including the following steps. A plurality of target information are received, and augmentation is performed on each of the target information to generate a plurality of augmented target information. Queried information and the augmented target information are received to extract features of the augmented target information and the queried information to respectively generate a plurality of augmented target feature values and a queried feature value. A recognition result is generated according to the queried feature value and the augmented target feature value.

To sum up, the data recognition apparatus provided by the disclosure generates multiple augmented target information through augmentation performed on each of the target information through the data augmentation device. The data recognition apparatus generates the recognition result according to the feature values of the augmented target information and the feature value of the queried information. The data recognition apparatus may be implemented as a memory. Based on the augmented target information, in the data recognition apparatus provided by the disclosure, recognition errors that may be caused by the error bits in the memory may be effectively lowered. Further, recognition errors that may occur between systems due to noise may be reduced, and accuracy rates of recognition are effectively improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating a data recognition apparatus according to an embodiment of the disclosure.

FIG. 2 is a schematic diagram illustrating generation of augmented target information in the data recognition apparatus according to an embodiment of the disclosure.

FIG. 3 is a schematic diagram illustrating implementation of a feature extractor according to an embodiment of the disclosure.

FIG. 4A and FIG. 4B are graphs illustrating relationships between recognition accuracy and bit resolution of the data recognition apparatus according to an embodiment of the disclosure.

FIG. 5 is a flow chart illustrating a data recognition method according to an embodiment of the disclosure.

FIG. 6 is a flow chart illustrating a data recognition method according to another embodiment of the disclosure.

### DESCRIPTION OF THE EMBODIMENTS

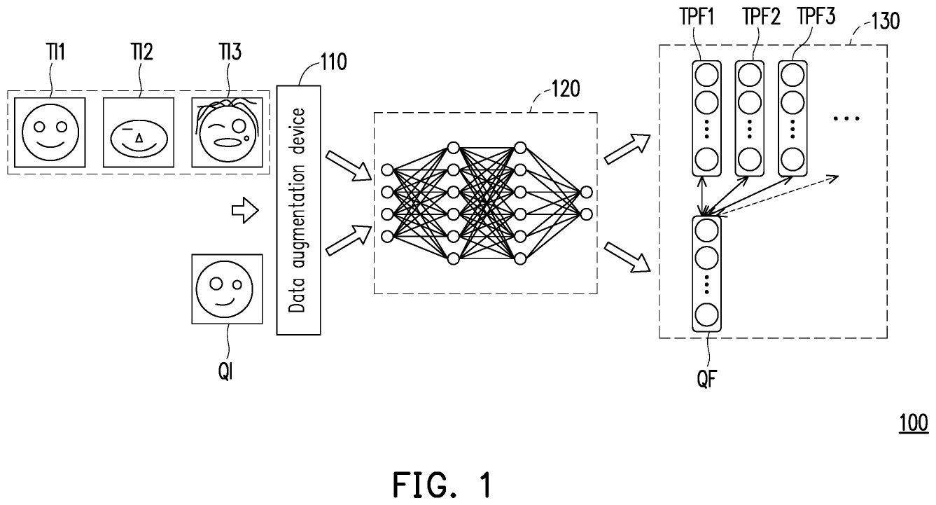

With reference to FIG. 1, FIG. 1 is a schematic diagram illustrating a data recognition apparatus according to an embodiment of the disclosure. A data recognition apparatus 100 includes a data augmentation device 110, a feature extractor 120, and a comparator 130. The data augmentation device 110 is configured to receive a plurality of target information TI1 to TI3. The data augmentation device 110 performs augmentation on each of the target information TI1 to TI3 to generate a plurality of augmented target information. The feature extractor 120 is coupled to the data augmentation device 110. The feature extractor 120 receives the augmented target information generated by the data augmentation device 110 and generates a plurality of augmented target feature values TPF1 to TPF3 through extracting features of the augmented target information. Further, the feature extractor 120 receives queried information QI and extracts a feature of the queried information QI to generate a queried feature value QF. The comparator 130 is coupled to the feature extractor 120. The comparator 130 compares the queried feature value QF with the augmented target feature values TPF1 to TPF3 and generates a recognition result according to recognition of similarity between the queried feature value QF and the augmented target feature values TPF1 to TPF3.

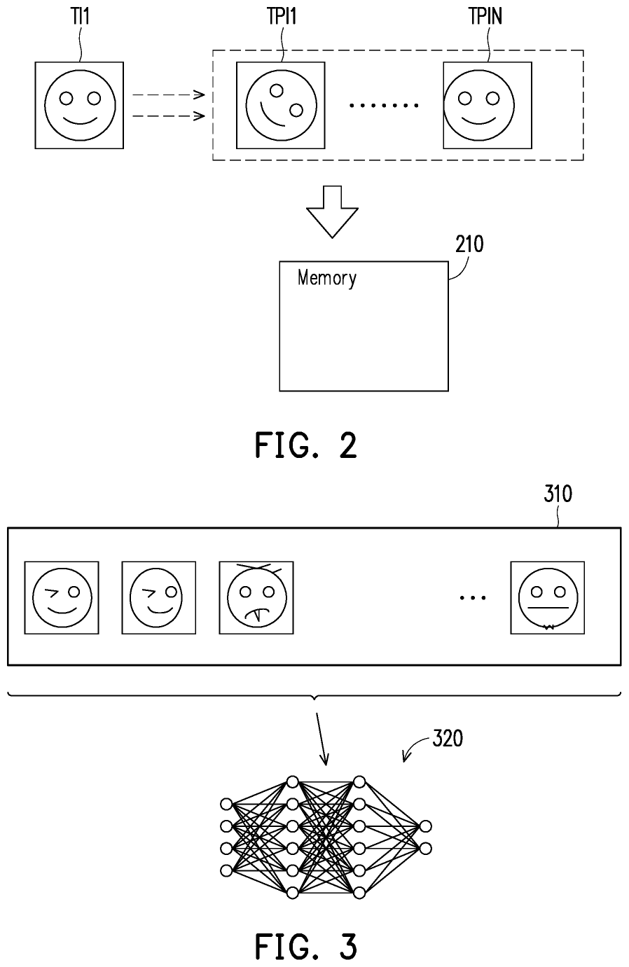

In this embodiment, the data augmentation device 110 may perform augmentation on each of the target information TI1 to TI3 through a plurality of manners. Herein, taking the target information TI1 to TI3 acting as image information as an example, the data augmentation device 110 may geometrically adjust each of the target information TI1 to TI3 to generate the augmented target information. In detail, the data augmentation device 110 may set each of the target information TI1 to TI3 to generate positional shifting or rotating or to generate shifting and rotating at the same time to generate the augmented target information. FIG. 2 is a schematic diagram illustrating generation of the augmented target information in the data recognition apparatus according to an embodiment of the disclosure. In FIG. 2, the data augmentation device 110 may set the target information TI1 to rotate to generate augmented target information TPI1. Herein, the data augmentation device 110 may set the target information TI1 to rotate at different angles to generate a plurality of augmented target information. Further, the data augmentation device 110 may also set the target information TI1 to shift to generate augmented target information TPIN. Herein, the data augmentation device 110 may set the target information TI1 to generate shifting of different degrees in different directions to generate a plurality of augmented target information. Besides, the data augmentation device 110 may also set the target information TI1 to rotate and to shift to generate the augmented target information.

In this embodiment, the augmented target information TPI1 to TPIN may be stored in a memory 210. The memory 210 may be a volatile memory or a non-volatile memory, which is not particularly limited.

In addition to shifting and rotating, the data augmentation device 110 may also set each of the target information TI1 to TI3 to generate shear deformation, set each of the target information TI1 to TI3 to generate flipping in a vertical direction and/or a horizontal direction, perform image cropping on each of the target information TI1 to TI3, perform image cropping-and-padding on each of the target information TI1 to TI3, perform perspective transforming on each of the target information TI1 to TI3, or perform elastic transforming on each of the target information TI1 to TI3 to generate the augmented target information TPI1 to TPIN.

In addition, in this embodiment, the data augmentation device 110 may also adjust a color of each of the target information TI1 to TI3 to generate the augmented target information. In detail, the data augmentation device 110 may also perform color sharpening, perform brightness adjustment, perform gamma-contrasting, or perform color inverting on each of the target information TI1 to TI3 to generate the augmented target information. In this embodiment, the data augmentation device 110 may further generate the augmented target information according to a generative adversarial model (GAM) for each of the target information TI1 to TI3. Herein, through the GAM, the data augmentation device 110 may add noise to each of the target information TI1 to TI3, obscure each of the target information TI1 to TI3, apply a transfer function to the X or Y axis (translate X or translate Y) of each target information TI1 to TI3, apply a coarse-salt effect to each of the target information TI1 to TI3, apply a super pixel effect to each of the target information TI1 to TI3, or apply an embossing effect to each of the target information TI1 to 113 to generate the augmented target information TPI1 to TPIN.

Besides, the data augmentation device 110 may also generate a thick fog effect or add special effects of weather patterns such as clouds and snow on each of the target information TI1 to 113 to generate the augmented target information TPI1 to TPIN.

In this embodiment, a data volume of the augmented target information TPI1 to TPIN may be 2 to 8 times a data volume of the target information TI1 to TI3.

Based on the above, since the memory 210 stores multiple groups of the augmented target information TPI1 to TPIN, the noise on the augmented target information TPI1 to TPIN is not required to be excessively attended to, and robustness to noise is provided. As such, the memory 210 does not have to check an error correcting code (ECC) of the read data, and the working speed of the system may thus be effectively improved.

Incidentally, when acting as a volatile memory, the memory 210 may be a static random-access memory (SRAM), a dynamic random-access memory (DRAM), a resistive random-access memory (ReRAM), a magnetoresistive random-access memory (MRAM), or a ferroelectric field-effect transistor (FeFET) memory. When acting as a non-volatile memory, the memory 210 may be a flash memory of any type.

In addition, the comparator 130 provided by the embodiments of the disclosure may be implemented as a processor with computing capability (e.g., a central processing unit (CPU), may be implemented as an application specific integrated circuit (ASIC), or may be implemented as an in-memory computation device. Taking the implementation by an in-memory computation device as an example, the in-memory computation device may store the augmented target feature values TPF1 to TPF3 to be multiplied and accumulated together with the queried feature value QF, so as to recognize the similarity between the augmented target feature values TPF1 to TPF3 and the queried feature value QF to accordingly generate the recognition result.

In an embodiment of the disclosure, the comparator 130 may be configured to perform a Hamming distance calculation, a cosine distance calculation, or an Euclidean distance calculation to calculate the similarity between the queried feature value QF and the augmented target feature values TPF1 to TPF3.

Herein, in this embodiment, the feature extractor 120 may be implemented by operations of an artificial neural network. The feature extractor 120 may also be implemented as a processor with computing capability (e.g., a CPU), may be implemented as an ASIC, or may be implemented as an in-memory computation device. An architecture of the artificial neural network in the feature extractor 120 may be determined by a designer and is not particularly limited.

The data augmentation device 110 in this embodiment may be implemented as a processor with computing capability (e.g., a CPU) or may be implemented as an ASIC, and implementation thereof is not particularly limited.

Taking a data recognition apparatus used in a company's security management system as an example, the data recognition apparatus 100 may be used to recognize whether a person entering or leaving the company is an employee of the company. A user may create multiple target information for all employees of the company. When the data recognition apparatus 100 is applied, the queried information may be compared with the target information, so as to learn whether the person corresponding to the queried information is an employee of the company and the person's access authority, so that the order of entering and leaving the company is effectively maintained.

With reference to FIG. 3, FIG. 3 is a schematic diagram illustrating implementation of a feature extractor according to an embodiment of the disclosure. A feature extractor 320 may be implemented by applying an artificial neural network operation. Herein, the feature extractor 320 may receive a plurality of sample information 310 and perform pre-training based on the sample information 310 to create nodes in an artificial neural network and a plurality of weight values. The feature extractor 320 may be a processor with computing capability, an ASIC, or an in-memory computation device.

The trained feature extractor 320 may be configured to execute features of the augmented target information and the queried information, and since related details are provided in the foregoing embodiments, description thereof is not repeated herein.

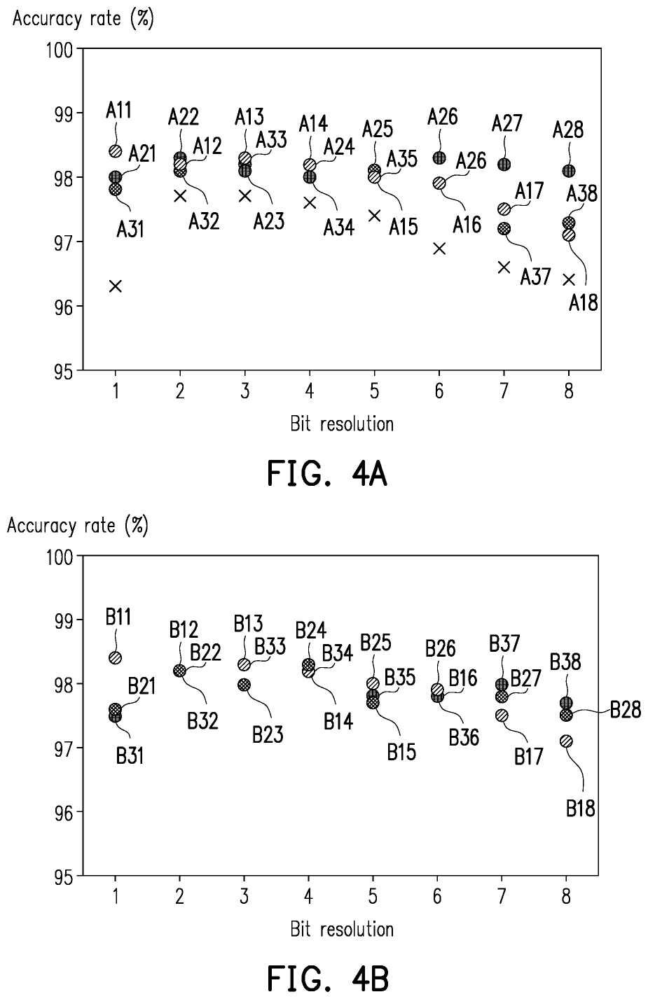

With reference to FIG. 4A and FIG. 4B, FIG. 4A and FIG. 4B are graphs illustrating relationships between recognition accuracy and bit resolution of the data recognition apparatus according to an embodiment of the disclosure. In FIG. 4A, the points marked with X are recognition accuracy rates generated by the data recognition apparatus without adding the augmented target information. Herein, when the points correspond to the same bit resolution and the augmented target information is not added, the recognition accuracy rate generate by the data recognition apparatus is the lowest. Marks A11 to A18 refer to the recognition accuracy rates corresponding to different bit resolutions when the augmented target information, which is 3 times the target information, is added. Marks A21 to A28 refer to the recognition accuracy rates corresponding to different bit resolutions when the augmented target information, which is 2 times the target information, is added. Marks A31 to A38 refer to the recognition accuracy rates corresponding to different bit resolutions when the augmented target information, which is 1 time the target information, is added. It can be seen in FIG. 4A that when moderate augmented target information is added, the recognition accuracy rates may be effectively increased.

In addition, in FIG. 4B, marks B11 to B18 are recognition correctness rates generated by the data recognition apparatus corresponding to different bit resolutions when there is no error bit when the augmented target information is stored. Marks B21 to B28 are the recognition correctness rates generated by the data recognition apparatus corresponding to different bit resolutions when 5% of the error bits occur when the augmented target information is stored. Marks B31 to B38 are the recognition correctness rates generated by the data recognition apparatus corresponding to different bit resolutions when 1% of the error bits occur when the augmented target information is stored. In can be seen in FIG. 4B that in the case that the augmented target information is added, the ratio of error bits generated by the memory does not have a significant impact on the recognition correctness of the data recognition apparatus.

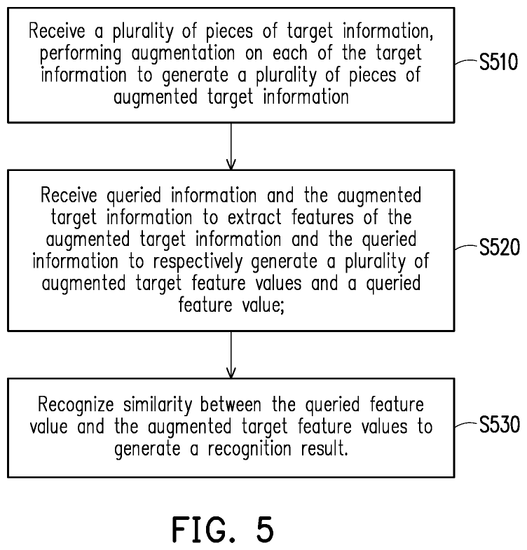

With reference to FIG. 5, FIG. 5 is a flow chart illustrating a data recognition method according to an embodiment of the disclosure. Herein, in step S510, a plurality of target information are received, and augmentation is performed on each of the target information to generate a plurality of augmented target information. Next, in step S520, queried information and the augmented target information are received to extract features of the augmented target information and the queried information to respectively generate a plurality of augmented target feature values and a queried feature value. Finally, in step S530, similarity between the queried feature value and the augmented target feature values is recognized to generate a recognition result.

Implementation details of the steps in this embodiment are described in the foregoing embodiments in detail, and description thereof is thus not repeated herein.

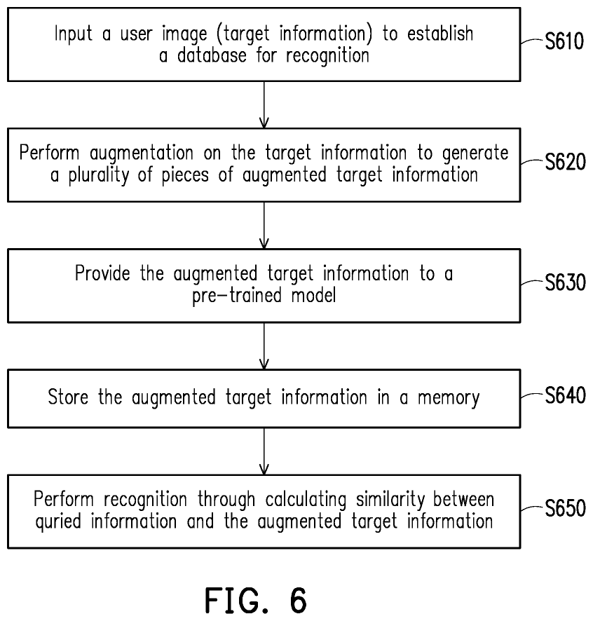

With reference to FIG. 6, FIG. 6 is a flow chart illustrating a data recognition method according to another embodiment of the disclosure. Recognition of a user image is treated as an example in the embodiment of FIG. 6. In step S610, a user image (target image) is inputted to establish a database for recognition. Next, in step S620, augmentation is performed on the target information to generate a plurality of augmented target information. In step S630, the augmented target information is provided to a pre-trained model. Herein, the pre-trained model may be a feature extractor. In step S640, the augmented target information is stored in a memory. Finally, in step S650, recognition is performed through calculating similarity between queried information and the augmented target information.

In view of the foregoing, the data recognition apparatus provided by the disclosure generates multiple augmented target information through augmentation performed on the target information. Further, the feature value of the queried information and the feature values of the augmented target information are compared. As such, the recognition result is obtained through looking up the similarity between the feature value of the queried information and the feature values of the augmented target information. The augmented target information provided by the disclosure exhibits high robustness to noise, so that a decrease in the recognition rate of the system as affected by noise may be prevented. In addition, a memory may be applied for implementation of the data recognition apparatus in the embodiments of the disclosure. Based on the improved robustness of the augmented target information, the ECC-free memory may be used to increase the computing speed of the data recognition apparatus.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A data recognition apparatus, comprising:
a data augmentation device, receiving a plurality of target information, performing augmentation on each of the target information to generate a plurality of augmented target information;
a feature extractor, coupled to the data augmentation device, receiving queried information and the augmented target information to extract features of the augmented target information and the queried information to respectively generate a plurality of augmented target feature values and a queried feature value; and
a comparator, generating a recognition result according to the queried feature value and the augmented target feature values.

2. The data recognition apparatus according to claim 1, wherein the data augmentation device geometrically adjusts each of the target information to generate the augmented target information.

3. The data recognition apparatus according to claim 2, wherein the data augmentation device sets each of the target information to generate at least one of positional shifting and rotating to generate the augmented target information.

4. The data recognition apparatus according to claim 1, wherein the data augmentation device adjusts a color of each of the target information to generate the augmented target information.

5. The data recognition apparatus according to claim 1, wherein the data augmentation device generates the augmented target information according to a generative adversarial model for each of the target information.

6. The data recognition apparatus according to claim 1, wherein a volume of the target information is ⅛ to ½ of a volume of the corresponding augmented target information.

7. The data recognition apparatus according to claim 1, further comprising:
a memory, configured to store the augmented target information, coupled to the data augmentation device and the feature extractor.

8. The data recognition apparatus according to claim 7, wherein the memory is a non-volatile memory or a volatile memory.

9. The data recognition apparatus according to claim 7, wherein the memory is a static random-access memory, a dynamic random-access memory, a resistive random-access memory, a magnetoresistive random-access memory, or a ferroelectric field-effect transistor memory.

10. The data recognition apparatus according to claim 1, wherein the comparator is an in-memory computation device, and the in-memory computation device stores the augmented target feature values and is configured to recognize the similarity between the queried feature value and the augmented target feature values to generate the recognition result.

11. The data recognition apparatus according to claim 1, wherein the comparator is configured to perform a Hamming distance calculation, a cosine distance calculation, or an Euclidean distance calculation to calculate the similarity between the queried feature value and the augmented target feature values.

12. A data recognition method, comprising:
receiving a plurality of target information, performing augmentation on each of the target information to generate a plurality of augmented target information;
receiving queried information and the augmented target information to extract features of the augmented target information and the queried information to respectively generate a plurality of augmented target feature values and a queried feature value; and
generating a recognition result according to the queried feature value and the augmented target feature values.

13. The data recognition method according to claim 12, wherein a step of performing augmentation on each of the target information to generate the augmented target information comprises:
geometrically adjusting each of the target information to generate the augmented target information.

14. The data recognition method according to claim 13, wherein a step of geometrically adjusting each of the target information to generate the augmented target information comprises:
setting each of the target information to generate at least one of positional shifting and rotating to generate the augmented target information.

15. The data recognition method according to claim 12, wherein a step of performing augmentation on each of the target information to generate the augmented target information comprises:
adjusting a color of each of the target information to generate the augmented target information.

16. The data recognition method according to claim 12, wherein a step of performing augmentation on each of the target information to generate the augmented target information comprises:
generating the augmented target information according to a generative adversarial model for each of the target information.

17. The data recognition method according to claim 12, wherein a volume of the target information is ⅛ to ½ of a volume of the corresponding augmented target information.

18. The data recognition method according to claim 12, wherein a step of generating the recognition result according to the similarity between the queried feature value and the augmented target feature values comprises:
providing an in-memory computation device; and
setting the in-memory computation device to store the augmented target feature values and to perform a similarity recognition operation between the queried feature value and the augmented target feature values to generate the recognition result.

19. The data recognition method according to claim 18, wherein a step of performing the similarity recognition operation between the queried feature value and the augmented target feature values to generate the recognition result comprises:
performing a Hamming distance calculation, a cosine distance calculation, or an Euclidean distance calculation to calculate the similarity between the queried feature value and the augmented target feature values.
